(19) United States
(12) Patent Application Publication
(10) Pub. No.: US 2015/0131983 A1
(43) Pub. Date: May 14, 2015

(54) REMOTE CONTROL ADAPTER FOR CAMERAS

(71) Applicant: Aspect Media Factory LLC, San Luis Obispo, CA (US)

(72) Inventors: David S. Thayer, San Luis Obispo, CA (US); Daniel S. Arbogast, San Luis Obispo, CA (US)

(21) Appl. No.: 14/540,760

(22) Filed: Nov. 13, 2014

Related U.S. Application Data
(60) Provisional application No. 61/903,817, filed on Nov. 13, 2013.

(51) Int. Cl. G03B 13/34

(52) U.S. Cl. CPC G03B 13/34
USPC 396/56

(57) ABSTRACT

A super-affordable wireless follow focus system designed for independent filmmakers, comprises a handheld remote transmitter unit (RTX-1) and the motor/receiver unit (DB-1) which attaches to the user's DSLR or video camera. The DB-1 lens motor is targeted towards DSLR and video cameras employing lenses with manual operation rings, but can be utilized with certain, heavier cinema lenses too. The system features open source, Arduino compatible firmware which enables a powerful array of user generated, optional settings. The system offers a flexible, wireless and user-friendly method of extending lens control to an assistant camera operator or “focus puller” enabling professional, cinematic filmmaking.

### RELATED APPLICATIONS

The present application claims priority under 37 CFR §119(e) to U.S. Provisional Application No. 61/903,817, filed Nov. 13, 2013, the contents of which are expressly incorporated herein.

### FIELD OF THE INVENTION

The present application relates to a modular control system which allows motor units to be affixed to still or motion cameras which allow customizable and programmable movement of the camera equipment during the course of filming/photography.

### BACKGROUND

Independent filmmakers find it hard to afford the standby Hollywood-style wireless follow focus solutions and so often go without. But these automated systems are essential took for next-level film making. Despite a number of attempts, such as disclosed in US Patent Publication 2012/0019665, filed Jul. 21, 2011, there remains a need for a more affordable and flexible system.

### SUMMARY

An affordable wireless follow focus system designed for independent filmmakers. The system includes a handheld remote transmitter unit and a motor/receiver unit which attaches to the user's DSLR or video camera. A programmable wireless radio transmitter controller enables the operator to alter the control surface interface such that the encoding and controlling dials, knobs and buttons may have customizable and user-defined ranges and function algorithms for the purpose of operating a stepper motor.

The application also includes a modular control system which allows motor units to be affixed to devices which allow alternate ways of moving camera equipment and devices during the course of filming/photography.

In a preferred embodiment, the receiver/motor controller is detachable and may be removed from the motor support arm unit allowing each of the pieces to be used independently or in conjunction. The motor, with its associated support arm, may be connected to a separate motor driver unit via interconnecting cables to be operated independently or as part of a larger, multi-unit system. Alternatively, the motor with its associated support arm may be married to a particular receiver/motordriver unit via a docking attachment method with no separate interconnecting cables apart for the docking ports incorporated in each unit.

The application also discloses a method of operating the manual control rings of a camera lens by using a remotely controlled stepper motor as an externally attached device. This can be done by using a belt to connect a drive motor to the lens of a still or moving image (video, film or digital cinema) camera. An arm bracket system may be used to enable various motor configurations.

The present application discloses a super-affordable wireless follow focus system designed for independent filmmakers, comprises a handheld remote transmitter unit (RTX-1) and the motor/receiver unit (DB-1) which attaches to the user's DSLR or video camera. The DB-1 lens motor is targeted towards DSLR and video cameras employing lenses with manual operation rings, but can be utilized with certain, heavier cinema lenses too. The system desirably features open source (www.opensource.org), Arduino compatible firmware (www.arduino.cc) which enables a powerful array of user generated, optional settings. The system offers a flexible, wireless and user-friendly method of extending lens control to an assistant camera operator or “focus puller” enabling professional, cinematic filmmaking

### DESCRIPTION OF THE DRAWINGS

In order to better describe the technical characteristics of the exemplary remote control adapters for cameras, the figures presented below are listed:

FIG. 1 is an orthographic view of the motor mounted on a camera with key parts called out;

FIG. 2 is a face diagram of the controller unit with parts called out as numbers with a key to the numbers, while FIG. 2A is an alternative “paintbrush” controller unit;

FIG. 3 is a block diagram of the operational modes of the controller;

FIG. 4 is a block diagram of the operation of the motor/receiver unit; and

FIGS. 5A and 5B are assembled and exploded diagrams of the motor, support arm and receiver box, with a numbered parts key.

### DETAILED DESCRIPTION

The present application provides an affordable wireless follow focus system designed for independent filmmakers, comprising a handheld remote transmitter unit (RTX-1) and the motor/receiver unit (DB-1) which attaches to the user's DSLR or video camera.

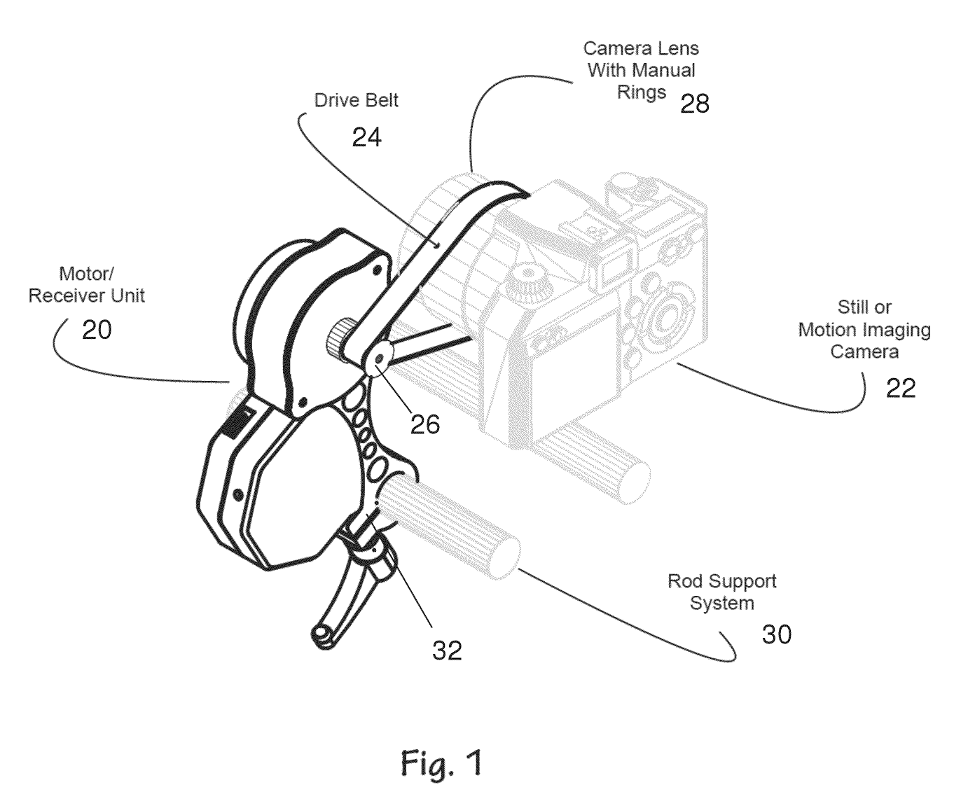

FIG. 1 shows a motor/receiving unit 20 mounted on a still or motion camera 22 and coupled thereto with a drive belt 24. More specifically, the drive belt 24 extends around a drive pulley 26 on the motor/receiving unit 20 and also around a focus ring 28 on the camera 22. A rod support system 30 attaches to a “dog-bone” support bracket 32 and enables the assembly to be hand-held or mounted to a tripod or other such stand (not shown).

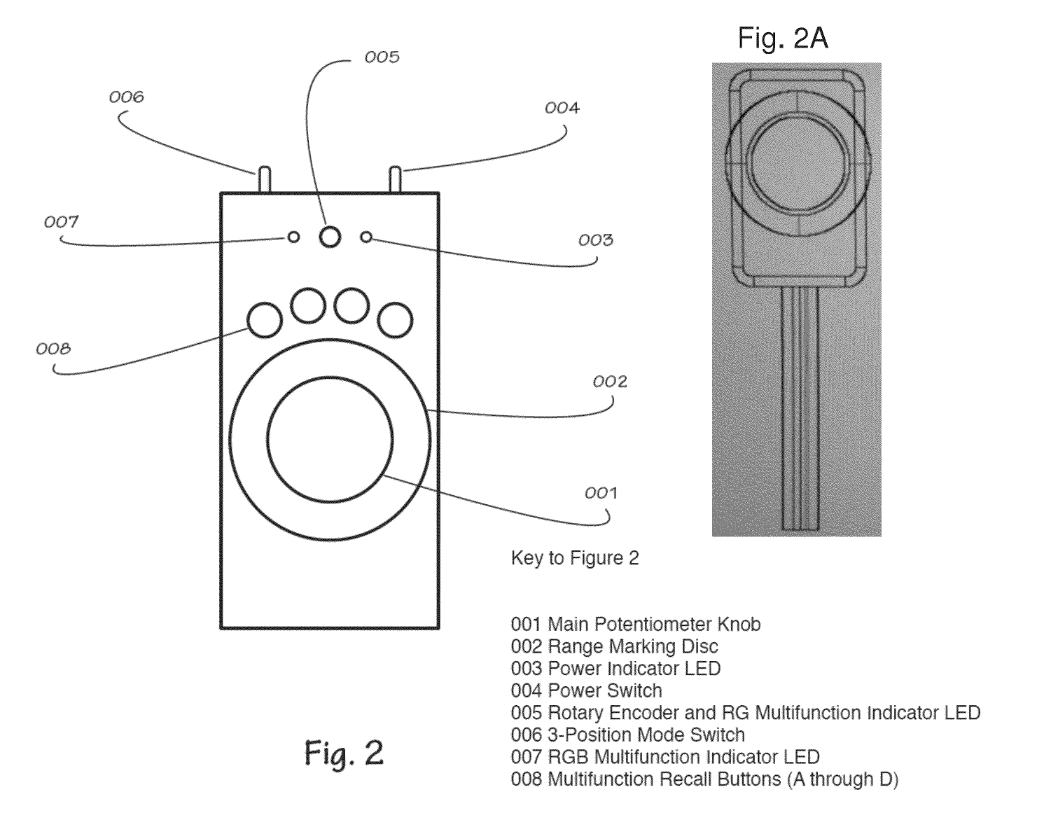

FIG. 2 is a face diagram of a hand-held controller unit 40 for the motor/receiving unit 20 with parts called out as numbers with a key to the numbers, as follows:
Part 001—Main potentiometer knob
Part 002—Range marking disc
Part 003—Power indicator LED
Part 004—Power switch
Part 005—Rotary encoder and RG multifunction indicator LED
Part 006—3-Position mode switch
Part 007—RGB multifunction indicator LED
Part 008—Multifunction recall buttons (A-D)

The hand-held control unit 40 is perfectly lightweight, and may be as small as a conventional smart phone or larger like a computer tablet. FIG. 2A is an alternative “paintbrush” controller unit with a handle on the bottom.

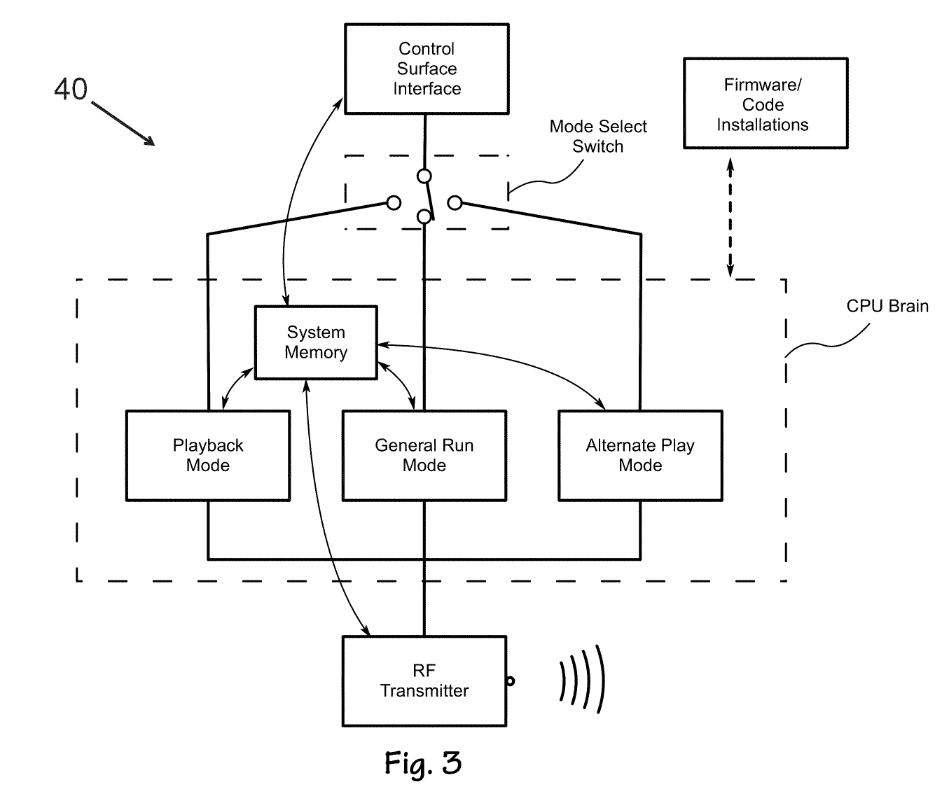

FIG. 3 is a block diagram of the operational modes of the controller unit 40. In general, the control buttons shown in FIG. 2 are provided on the control surface interface, and send instructions to a mode select switch. The mode select switch can choose between Playback, General Run, and Alternate Play modes, all informed by and saved in a system memory. Optimally, instructions are output to an RF transmitter to send the information to a receiver on the motor/receiving unit 20. Firmware/code installations run the various subroutines using a CPU brain.

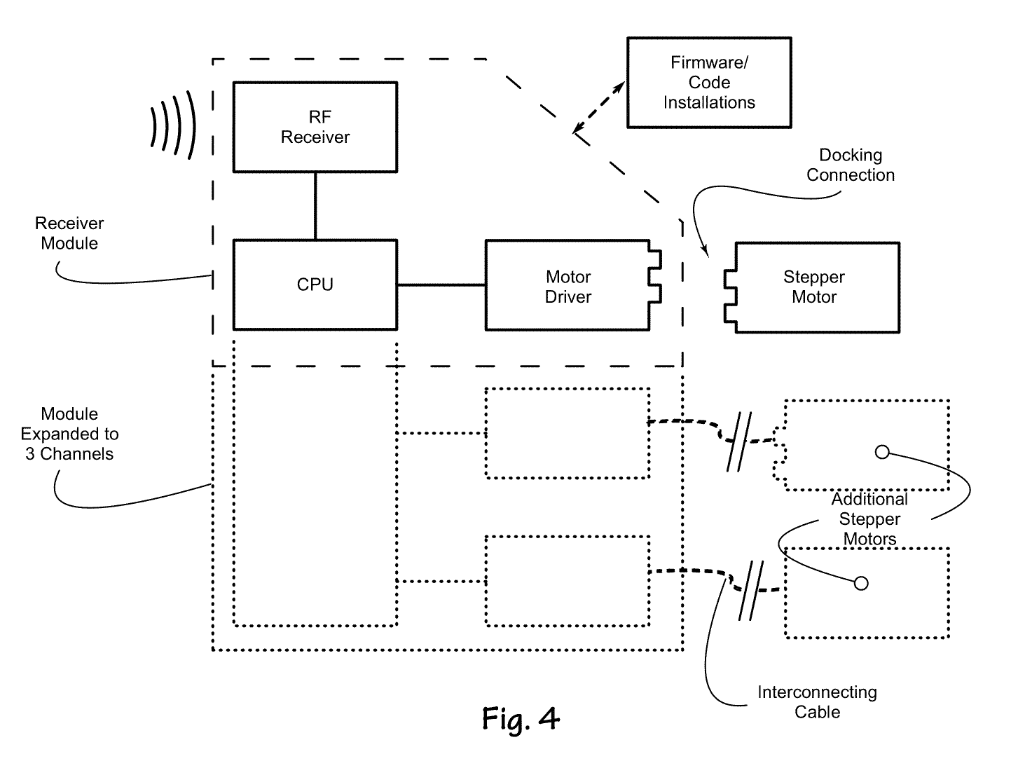

FIG. 4 is a block diagram of the operation of the motor/receiver unit 20. Again, firmware/code installations are provided for a CPU unit connected to a motor driver. An RF receiver receives the instructions from the control unit 40, and initiates one of the play modes. A motor driver provides an output to a stepper motor which is docked therewith. If needed, the motor/receiving and 20 may be expanded to three channels and have three motor drivers and three stepper motors. For example, the motor/receiver unit 20 may be capable of simultaneously adjusting focus, tilt, and swivel of the camera 22.

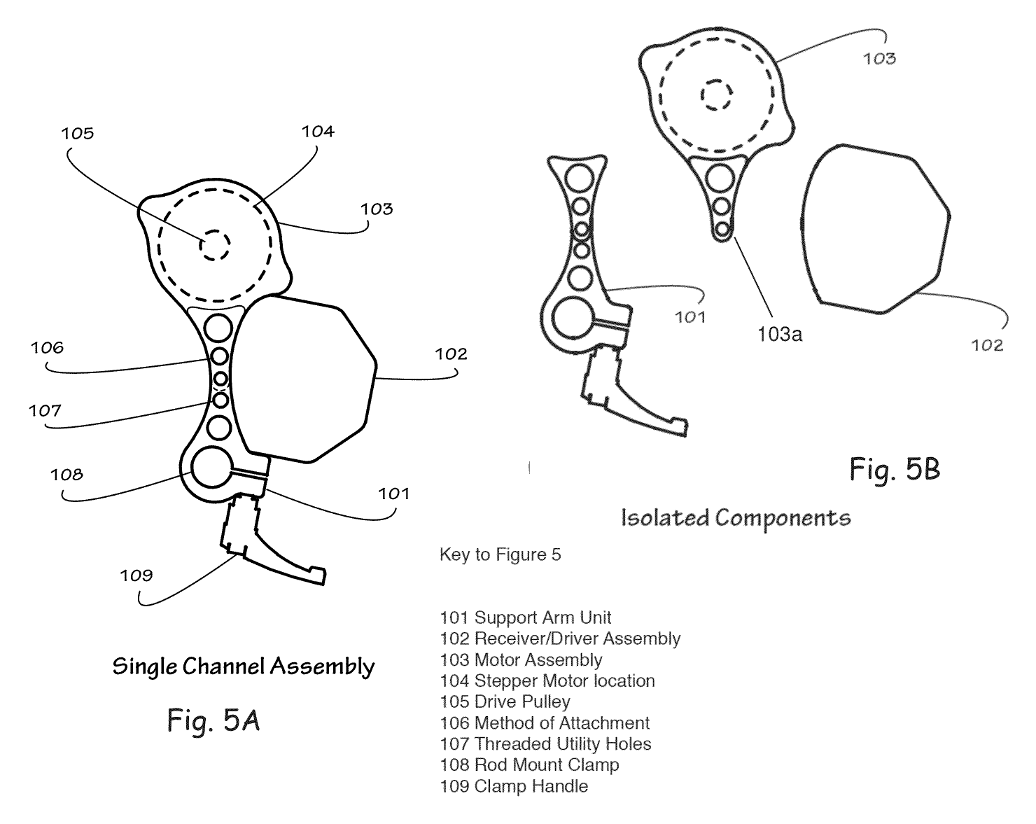

FIGS. 5A and 5B are assembled and exploded diagrams of the dog-bone support bracket 101 connected to the motor/receiver drive assembly 102. In a preferred embodiment, a motor assembly 103 includes a flange 103a that attaches to a similarly shaped flange 106 extending from the Y-shaped support bracket 101. The two parts may be bolted together in this manner using corresponding utility holes 107. The motor assembly 103 includes the stepper motor 104 whose location is shown in phantom, and a central drive pulley 105 through which a drive belt (not shown) may be powered. A rod mount clamp 108 forms a lower end of the dog-bone support bracket 101 and may be attached to a handle or other such rod of a tripod or stand using a threaded or cammed clamp 109. The support bracket 101 is desirably a water-jet aluminum cutout.

In use, simply slide the DB-1 Motor Unit onto your camera's 15 mm (or 19 mm) rod support system, slip on the lens belt, adjust tension and lock into place. Plug in the battery and with a flip of a switch, you're ready to go. The system will work with virtually any DSLR lens with a manual lens ring on the market.

DB-1 Motor/Receiver Features:
Anodized aluminum Dogbone
Works with industry standard 15 mm iris rod systems
Lightweight; just over 8 ounces (230 grams)
Can drive any stepper motor up to 1.5 A/phase (see Detachable Receiver stretch goal for more on additional motors)
Flexible power requirements allowing it to work with battery systems beyond the included 12v battery pack
Mini-USB port for firmware uploads

The RTX-1 is a wireless remote control transmitter. Now your follow focus operator can give the camera operator some breathing room! Its compact, about the size of a smart phone, making it a comfortable fit in your hands for those production days that never seem to end. The remote itself uses a familiar industry follow focus knob design and range-marking disc; essential features for the assistant camera operator (AC) to reliably hit their marks on set.

RTX-1 Remote Controller Features:
Large, industry-style, primary focus knob
4 Preset Buttons to set and recall positions
Tough Lexan and anodized aluminum case to withstand years of abuse
Compact design measuring roughly 3×6 inches
White distance marking disk for dry-erase or China marker
Uses four AAA batteries, providing up to 80 hours of operation
Mini-USB port for firmware upgrades and custom “Z-mode” programming beyond basic follow focus operation

The controller may be programmed to serve multiple functions and to be customized by the user. You can push the limits of the hardware and experiment on your own to create complex moves, adjust the speed profile curves or change the timing parameters allowing you, for example, to enable very slow, time-lapse type of functionality. The open source nature of the firmware allows you to change the parameters in the default modes (Freerun and Playback) if you choose, but a user-defined Z-mode is designed to enable access to that customization at the flip of a switch while preserving the default functionality of the other two modes. Preferably, a Web and desktop application for both Mac and PC are available along with a code repository for defaults, upgrades and user-generated code.

While the DB-1 is shown as a combined receiver/motor unit, it may also be detachable from the dogbone motor units. The receiver units can operate with almost any stepper motor on the market, and this would make it easy to run stepper motors with different power capabilities, or dedicated to different functions like camera jibs, sliders, aerial rigs or just about any other camera movement imaginable.

While several embodiments have been described that are exemplary of the present system and methods, one skilled in the art will recognize additional embodiments within the spirit and scope of the systems and methods described herein. Modification and variation can be made to the disclosed embodiments without departing from the scope of the disclosure.

What is claimed is:

1. A modular control system which allows motor units to be affixed to devices which allow alternate ways of moving camera equipment and devices during the course of filming/photography, wherein;
a receiver/motor controller is detachable and may be removed from a motor support arm unit allowing each of the pieces to be used independently or in conjunction, the motor, with its associated support arm, may be connected to a separate motor driver unit via interconnecting cables to be operated independently or as part of a larger, multi-unit system.
